(19) United States
(12) Patent Application Publication
(10) Pub. No.: US 2026/0024909 A1
(43) Pub. Date: Jan. 22, 2026

(54) RADIATING ELEMENT FOR BASE STATION ANTENNA AND BASE STATION ANTENNA

(71) Applicant: Outdoor Wireless Networks LLC, Claremont, NC (US)

(72) Inventors: Pengfei GUO, Suzhou (CN); Changfu CHEN, Suzhou (CN)

(21) Appl. No.: 18/875,288

(22) PCT Filed: Jul. 12, 2023
(86) PCT No.: PCT/US2023/070009

§ 371 Date: Dec. 16, 2024

(30) Foreign Application Priority Data
Jul. 12, 2022 (CN) 202210816617.5

(51) Int. Cl. H01Q 1/24; H01Q 1/48; H01Q 9/04; H01Q 19/10; H01Q 21/08

(52) U.S. Cl. CPC H01Q 1/246; H01Q 1/48; H01Q 9/0414; H01Q 19/10; H01Q 21/08

(57) ABSTRACT

The present disclosure relates to a radiating element for a base station antenna, including: a feeding balun; a radiator mounted at a top of the feeding balun, configured to emit an electromagnetic radiation within an operating frequency band of the radiating element; and an artificial magnetic conductor (AMC) structure mounted below the radiator, configured to enable the electromagnetic radiation within the operating frequency band to be in-phase reflected, where a distance between the AMC structure and a bottom of the radiator is less than 1/10 of a height of the feeding balun. The present disclosure further relates to a base station antenna.

### CROSS-REFERENCE TO RELATED APPLICATION(S)

This application claims priority to Chinese Application No. 202210816617.5, filed in the Chinese National Intellectual Property Administration on Jul. 12, 2022, the disclosure of which is hereby incorporated by reference herein in its entirety.

### FIELD

The present disclosure relates to a communication system, and more particularly, to a radiating element for a base station antenna and a base station antenna.

### BACKGROUND

Each cell in a cellular communication system has one or more base station antennas configured to provide bi-directional wireless/radio frequency (RF) communications to a mobile user geographically located within a given cell. A plurality of base station antennas are typically used, and each base station antenna is configured to provide service to one sector of the cell. In cellular base stations with a conventional 3-sector configuration, each sector antenna is typically desired to have a beam width of approximately 65° (when referred to herein as “beam width”, unless specifically indicated, all refer to azimuth plane half-power (−3 dB) beam width).

FIG. 1 is a schematic structural diagram of a conventional base station 60. The base station 60 includes a base station antenna 50 that can be mounted on a raised structure 30. The raised structure 30 may be an antenna tower. However, it should be understood that a variety of mounting locations may be used, including, for example, utility poles, buildings, and water towers. The base station 60 also includes base station devices such as a baseband unit 40 and a radio 42. In order to simplify the drawing, a single baseband unit 40 and a single radio 42 are shown in FIG. 1. However, it should be understood that more than one baseband unit 40 and/or radio 42 may be provided. In addition, although the radio 42 is shown as being co-located with the baseband unit 40 at the bottom of the convex structure 30, it should be understood that in other cases, the radio 42 may be a remote radio head mounted on the raised structure 30 adjacent to the antenna. The baseband unit 40 can receive data from another source, such as a backhaul network (not shown), process the data and provide a data stream to the radio 42. The radio 42 can generate RF signals including data encoded therein and can amplify and transmit these RF signals to the base station antenna 50 for transmission through a cable connection 44. It should also be understood that the base station 60 of FIG. 1 may generally include various other devices (not shown), such as a power supply, a backup battery, a power bus, an antenna interface signal group (AISG) controller, and the like.

### SUMMARY

One of the purposes of the present disclosure is to provide a radiating element for a base station antenna and a base station antenna.

According to a first aspect of the present disclosure, a radiating element for a base station antenna is provided, including: a feeding balun; a radiator mounted at a top of the feeding balun, configured to emit an electromagnetic radiation within an operating frequency band of the radiating element; and an artificial magnetic conductor (AMC) structure mounted below the radiator, configured to enable the electromagnetic radiation within the operating frequency band to be in-phase reflected, where a distance between the AMC structure and a bottom of the radiator is less than 1/10 of a height of the feeding balun.

According to a second aspect of the present disclosure, a radiating element for a base station antenna is provided, including: a feeding balun; and a PCB board mounted at a top of the feeding balun, the PCB board including a first dielectric layer, where a first metal pattern layer is configured on a top surface of the first dielectric layer to form a radiator configured to emit an electromagnetic radiation within an operating frequency band of the radiating element; and a second metal pattern layer is configured on a bottom surface of the first dielectric layer to form a first AMC plane, the first AMC plane being configured to enable the electromagnetic radiation within the operating frequency band to be in-phase reflected, where a distance from the PCB board to a bottom of the feeding balun is less than ⅛ of a corresponding wavelength of a center frequency of the operating frequency band.

According to a third aspect of the present disclosure, a base station antenna is provided, including: a reflector; and the above radiating element, where a bottom of a feeding balun of the radiating element is mounted on the reflector, so that the radiating element extends from the reflector to the front of the base station antenna.

Through the following detailed description of exemplary embodiments of the present disclosure by referencing the attached drawings, other features and advantages of the present disclosure will become clear.

### BRIEF DESCRIPTION OF THE DRAWINGS

The attached drawings, which form a part of the specification, describe embodiments of the present disclosure and, together with the specification, are used to explain the principles of the present disclosure, in which:

FIG. 1 is a schematic structural diagram of a conventional base station;

FIG. 2A and FIG. 2B are front and side views, respectively, of a conventional radiating element when mounted on a reflector;

FIG. 3A and FIG. 3B are front and side views, respectively, of a radiating element according to an embodiment of the present disclosure when mounted on a reflector;

FIG. 4A and FIG. 4B are front and side views, respectively, of a radiating element according to an embodiment of the present disclosure when mounted on a reflector;

FIG. 5A is a schematic diagram of an AMC plane and a reflector in a radiating element according to an embodiment of the present disclosure;

FIG. 5B is a graph when a reflection phase of an AMC plane in a radiating element according to an embodiment of the present disclosure changes with frequency;

FIGS. 6A-6F are front views of an AMC plane in a radiating element according to an embodiment of the present disclosure;

FIGS. 7A-7C are schematic side views of a radiator and an AMC plane in a radiating element according to an embodiment of the present disclosure;

FIG. 8A and FIG. 8B are schematic side views of a radiator and an AMC plane in a radiating element according to an embodiment of the present disclosure;

FIG. 9A is a perspective view of a base station antenna including the conventional radiating elements shown in FIGS. 2A and 2B;

FIG. 9B is a perspective view of a base station antenna including the radiating elements shown in FIGS. 3A and 3B;

FIG. 9C is a perspective view of a base station antenna including the radiating elements shown in FIGS. 4A and 4B;

FIG. 10A and FIG. 10B are respective graphs illustrating the variation of the beam width as a function of frequency for the antenna beams generated by the base station antenna of FIG. 9A and FIG. 9B; and

FIG. 11A and FIG. 11B are respective graphs illustrating the variation of the beam directivity as a function of frequency for the antenna beams generated by the base station antenna of FIG. 9A and FIG. 9B.

Note that in the embodiments described below, the same reference signs are sometimes jointly used between different attached drawings to denote the same parts or parts with the same functions, and repeated descriptions thereof are omitted. In some cases, similar labels and letters are used to indicate similar items. Therefore, once an item is defined in one attached drawing, it does not need to be further discussed in subsequent attached drawings.

For ease of understanding, the position, dimension, and range of each structure shown in the attached drawings and the like sometimes may not indicate the actual position, dimension, and range. Therefore, the present disclosure is not limited to the positions, dimensions, and ranges disclosed in the attached drawings and the like.

### DETAILED DESCRIPTION

The present disclosure will be described below with reference to the attached drawings, wherein the attached drawings illustrate certain embodiments of the present disclosure. However, it should be understood that the present disclosure may be presented in many different ways and is not limited to the embodiments described below; in fact, the embodiments described below are intended to make the disclosure of the present disclosure more complete and to fully explain the protection scope of the present disclosure to those of ordinary skill in the art. It should also be understood that the embodiments disclosed in the present disclosure may be combined in various ways so as to provide more additional embodiments.

It should be understood that the terms used herein are only used to describe specific embodiments, and are not intended to limit the scope of the present disclosure. All terms used herein (including technical terms and scientific terms) have meanings normally understood by those skilled in the art unless otherwise defined. For brevity and/or clarity, well-known functions or structures may not be further described in detail.

As used herein, when an element is said to be “on” another element, “attached” to another element, “connected” to another element, “coupled” to another element, or “in contact with” another element, etc., the element may be directly on another element, attached to another element, connected to another element, coupled to another element, or in contact with another element, or an intermediate element may be present. In contrast, if an element is described as “directly” “on” another element, “directly attached” to another element, “directly connected” to another element, “directly coupled” to another element or “directly in contact with” another element, there will be no intermediate elements. As used herein, when one feature is arranged “adjacent” to another feature, it may mean that one feature has a part overlapping with the adjacent feature or a part located above or below the adjacent feature.

In this specification, elements, nodes or features that are “coupled” together may be mentioned. Unless explicitly stated otherwise, “coupled” means that one element/node/feature can be mechanically, electrically, logically or otherwise connected with another element/node/feature in a direct or indirect manner to allow interaction, even though the two features may not be directly connected. That is, “coupled” is intended to comprise direct and indirect connection of components or other features, including connection using one or a plurality of intermediate components.

As used herein, spatial relationship terms such as “upper”, “lower”, “left”, “right”, “front”, “back”, “high” and “low” can explain the relationship between one feature and another in the drawings. It should be understood that, in addition to the orientations shown in the attached drawings, the terms expressing spatial relations also comprise different orientations of a device in use or operation. For example, when a device in the attached drawings rotates reversely, the features originally described as being “below” other features now can be described as being “above” the other features”. The device may also be oriented by other means (rotated by 90 degrees or at other locations), and at this time, a relative spatial relation will be explained accordingly.

As used herein, the term “A or B” comprises “A and B” and “A or B”, not exclusively “A” or “B”, unless otherwise specified.

As used herein, the term “exemplary” means “serving as an example, instance or explanation”, not as a “model” to be accurately copied”. Any realization method described exemplarily herein may not be necessarily interpreted as being preferable or advantageous over other realization methods. Furthermore, the present disclosure is not limited by any expressed or implied theory given in the above technical field, background art, summary of the invention or embodiments.

As used herein, the word “basically” means including any minor changes caused by design or manufacturing defects, device or component tolerances, environmental influences, and/or other factors. The word “basically” also allows for the divergence from the perfect or ideal situation due to parasitic effects, noise, and other practical considerations that may be present in the actual realization.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

It should also be understood that when the term “comprise/include” is used herein, it indicates the presence of the specified feature, entirety, step, operation, unit and/or component, but does not exclude the presence or addition of one or a plurality of other features, steps, operations, units and/or components and/or combinations thereof.

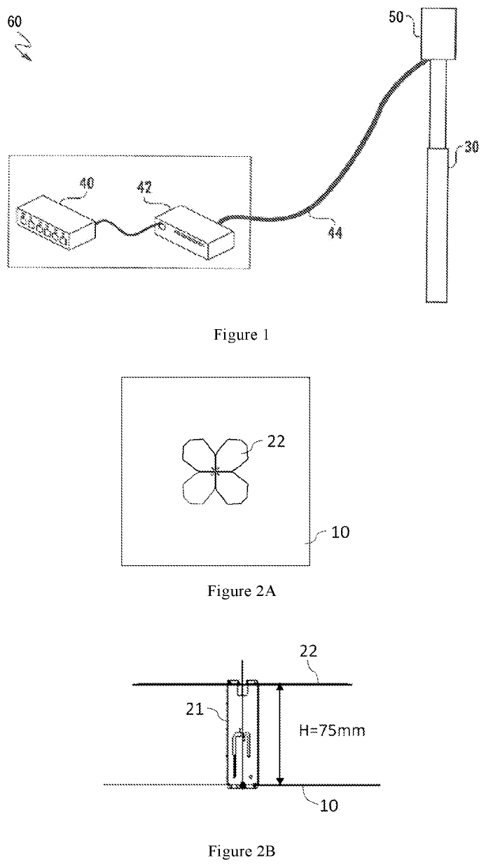

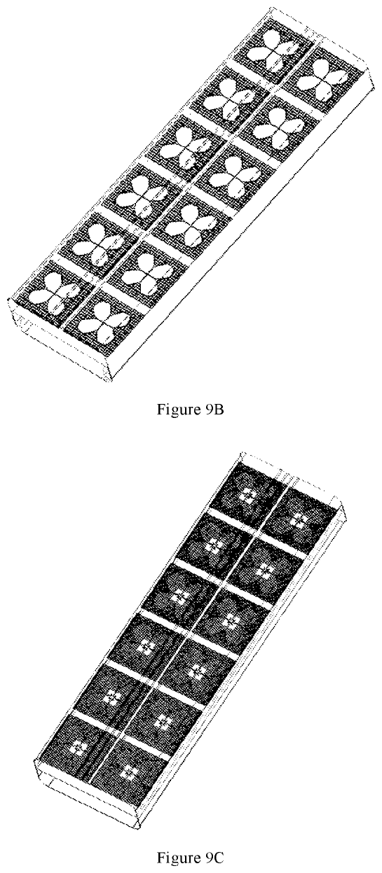

FIG. 2A and FIG. 2B are front and side views, respectively, of a conventional radiating element when mounted on a reflector 10. The radiating element includes a feed stalk 21 that includes a pair of hook baluns (only a portion of each hook balun is visible in FIG. 2B) and a radiator 22 mounted at a top of the feed stalk 21. The feed stalk 21 may hold and feed the radiator 22 so that the radiator 22 may emit electromagnetic radiation within an operating frequency band of the radiating element. When the radiating element is mounted in a base station antenna, an end of the feed stalk 21 that is opposite the radiator 22 is mounted on the reflector 10, so that when the base station antenna is mounted on a raised structure (for example, the antenna tower 30 shown in FIG. 1) for operation, the radiating element extends forwardly from the reflector 10 toward the front of the base station antenna (i.e., the radiating element extends in a main radiation direction of the antenna beams emitted by the radiating element), as shown in FIG. 9A. It should be noted that, unless otherwise specified, the “top”, “bottom”, “upper”, “lower”, “high” and other terms related to spatial orientation used when describing the structure of the radiating elements of the present disclosure are all referenced by the viewing angles shown in FIGS. 2B, 3B and 4B.

The operating frequency band of the radiating element shown in FIG. 2A and FIG. 2B is 0.69-0.96 GHZ, and a distance between the radiator 22 and the reflector 10, that is, an approximate height of the feed stalk 21, is about 75 mm, which is approximately equal to ¼ of a wavelength corresponding to a center frequency of the operating frequency band of the radiating element. Since the reflector 10 typically includes a perfect electric conductor (PEC) ground plane, a phase shift of 180 degrees occurs when an electromagnetic wave is incident on the PEC reflector 10, thereby forming a phase difference of 180 degrees between the incident electromagnetic wave and a reflected electromagnetic wave. Thus, in this case, in order for a forwardly propagating electromagnetic wave emitted by the radiator 22 to be constructively combined (i.e., constructive interference) with a backwardly propagating electromagnetic wave when emitted from the radiator 22 but redirected to forwardly propagating by the reflector 10 to obtain a preferable gain, the radiator 22 needs to be positioned at a separation distance of approximately ¼ of a center wavelength (the wavelength corresponding to the center frequency of the operating frequency band) from the PEC reflector 10.

Radiating elements according to the embodiments of the present disclosure are described below with reference to the accompanying drawings. To not obscure the subject matter of the present disclosure, description of the same or similar structures and configurations as the conventional radiating element described above will be omitted.

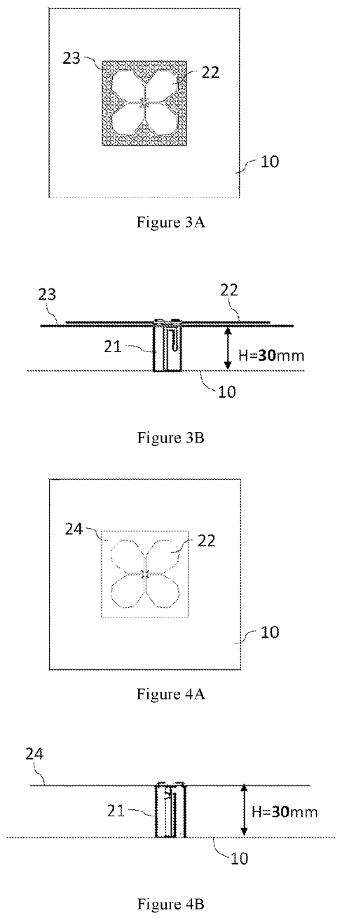

FIG. 3A and FIG. 3B are front and side views, respectively, of a radiating element according to an embodiment of the present disclosure when mounted on a reflector 10. The radiating element includes a feed stalk 21, a radiator 22 mounted at a top of the feed stalk 21, and an artificial magnetic conductor (AMC) structure 23 mounted below the radiator 22. The radiator 22 and the AMC structure 23 may be supported by a support to separate the two. The support may be the feed stalk 21 or another support.

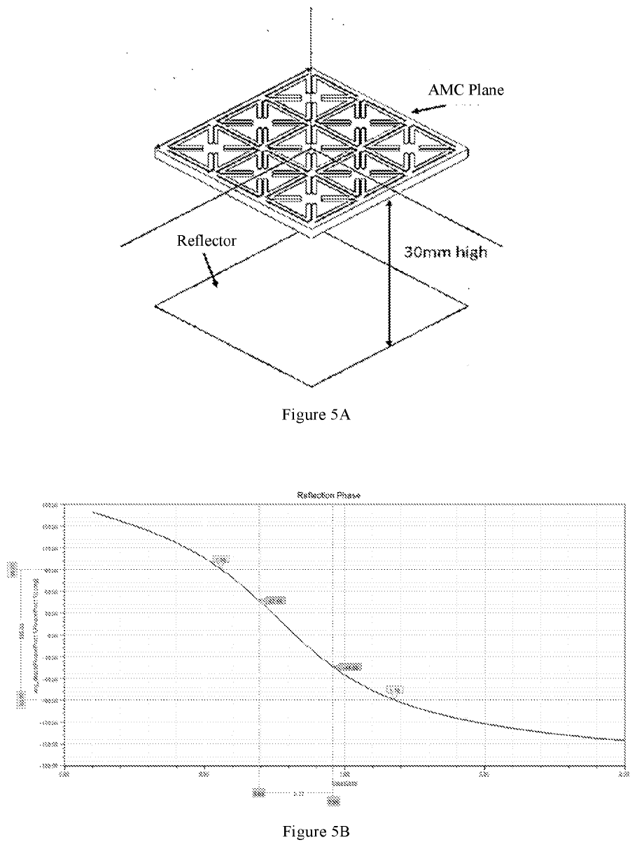

The term “AMC structure” referred to herein refers to a structure capable of cooperating with an perfect electrical conductor (PEC) to exhibit the characteristics of an AMC. In embodiments of the present disclosure, the AMC structure may include one AMC plane or stacked more AMC planes. For brevity, a periodic surface formed by repeatedly arranged pattern units composed of metal conductors is referred to as the AMC plane in the present disclosure. As shown in FIG. 5A, the AMC plane together with a reflector including a PEC forms an AMC so as to exhibit the characteristics of an AMC. The AMC may have a plurality of repeated pattern units arranged at preset intervals to form resonances at a specific frequency, so that the AMC has the characteristics of magnetic conductors, and its reflected waves do not produce a phase shift of 180 degrees relative to incident waves at the specific frequency. For example, in the case where an electromagnetic wave having the same frequency as the resonance frequency is incident on the AMC plane, the AMC plane reflects the electromagnetic wave and the phase of the reflected electromagnetic wave will be the same as the phase of the incident electromagnetic wave. As a result, the incident electromagnetic wave and the reflected electromagnetic wave will not cause cancellation interference with each other, and will produce a synergistic effect on the radiation of the electromagnetic waves through constructive interference.

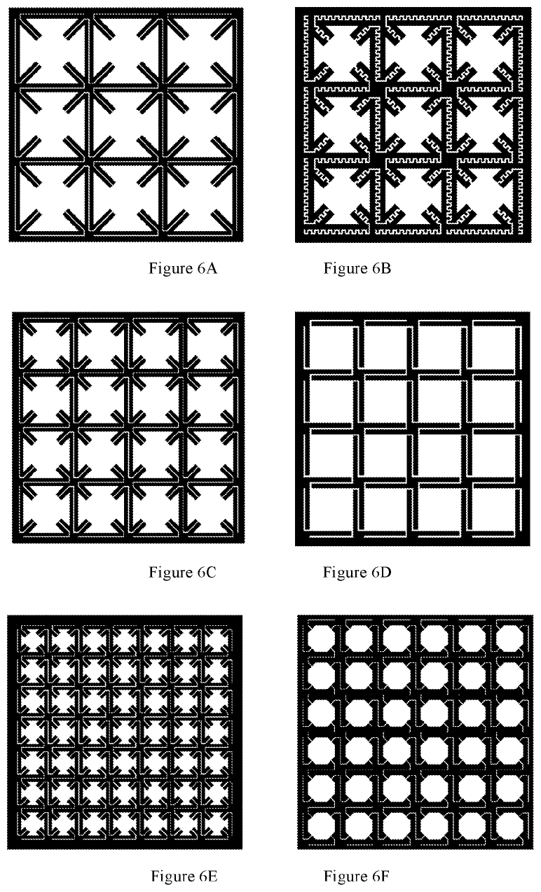

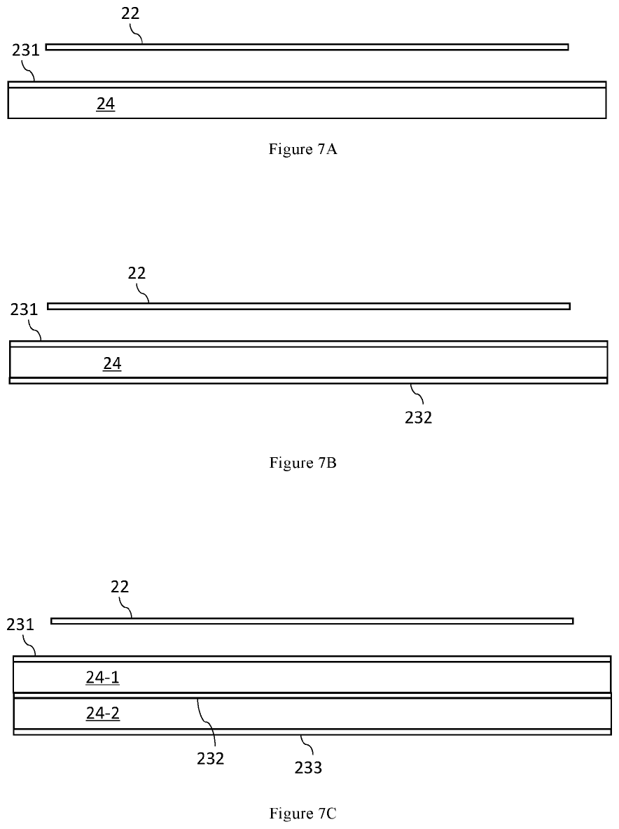

The shape of the Pattern unit arranged in each of the one or more AMC planes included in the AMC structure 23 need not be defined, for example, its profile may be a circular shape, a polygonal shape, etc. In some specific examples, metal patterns included in each AMC plane may be as shown in FIGS. 6A-6F. The number of times the pattern unit is repeated (3 times for the pattern unit shown in FIGS. 6A and 6B, 4 times for that shown in FIGS. 6C and 6D, 7 times for that shown in FIG. 6E, and 6 times for that shown in FIG. 6F) can also be determined as needed. Typically, the more pattern units that are repeatedly arranged are included, the higher the gain of the radiating element. The interval between adjacent pattern units may be much shorter than the wavelength corresponding to the resonance frequency, for example, equal to or less than one-tenth of the wavelength corresponding to the resonance frequency.

The shape and dimensions of the pattern units in the AMC plane, the spacing between adjacent pattern units, the number of pattern units that are periodically repeated in their transverse and longitudinal directions, and the spacing distance between the AMC structure 23 and the reflector 10 may be designed, so that the AMC formed by the AMC structure 23 and the reflector 10 can reflect electromagnetic radiation emitted by the radiating element in-phase. For example, the resonance frequency of the AMC structure 23 may be basically the same as the center frequency of the operating frequency band of the radiating element. It should be noted that in-phase reflection referred to in the present disclosure means that a phase offset of a reflected wave relative to an incident wave is between-90 degrees and +90 degrees. As shown in FIG. 5B, an operating frequency range of a radiating element corresponding to the AMC structure is 0.56-1.18 GHz when the reflection phase is between-90 degrees and +90 degrees in the radiating element according to the embodiment of the present disclosure, and the operating frequency band 0.69-0.96 GHz of the radiating element shown in FIG. 3A and FIG. 3B can be covered.

FIGS. 6A-6F are front views of one or more AMC planes included in an AMC structure that can be used to form radiating elements according to embodiments of the present disclosure. As shown in FIGS. 6A-6F, each conductor pattern unit in the AMC plane may include one capacitive element and four inductive elements connected in series to the capacitive element. Each of the four inductive elements is connected to the capacitive element from a corresponding junction point of four junction points, which are evenly distributed on an outer edge of the capacitive element. One or more of the four inductive elements are connected in series to a corresponding capacitive element in an adjacent pattern unit. The inductive elements may include a conductive trace that at least partially surrounds the capacitive element. In some embodiments, the inductive elements may include serpentine conductive traces. The AMC plane with such a structure can achieve a significant in-phase reflection effect in a wide frequency band, such as the operating frequency band 0.69-0.96 GHz of the radiating element.

Since the AMC structure 23 is configured to enable electromagnetic radiation within the operating frequency band of the radiating element to be reflected in-phase, the radiator 22 of the radiating element may be positioned with a spacing distance from the reflector 10 that is less than ¼ of a center wavelength. The operating frequency band of the radiating element shown in FIG. 3A and FIG. 3B is 0.69-0.96 GHZ, and a distance between the radiator 22 and the reflector 10, that is, an approximate height of the feed stalk 21, is about 30 mm. This value is less than ¼ of a wavelength corresponding to a center frequency of the operating frequency band of the radiating element, and even less than ⅛ of the wavelength. This allows a base station antenna that includes radiating elements according to embodiments of the present disclosure to have a lower profile, which is conducive to miniaturization of the antenna.

In addition, in the radiating element shown in FIG. 3A and FIG. 3B, the distance between the AMC structure 23 and the radiator 22 is small, for example, the distance between the AMC structure 23 and the bottom of the radiator 22 is less than 1/10 of the height of the feed stalk 21. In a plan view parallel to a surface of the AMC structure 23, an area of the AMC structure 23 completely covers an area of the radiator 22, and an outer edge of the AMC structure 23 exceeds an outer edge of the radiator 22. In order to minimize the size of the radiating element, the area of the AMC structure 23 needs to be only slightly larger than the area of the radiator 22.

FIG. 4A and FIG. 4B are front and side views, respectively, of a radiating element according to an embodiment of the present disclosure when mounted on a reflector 10. In this embodiment, the radiating element includes a feed stalk 21 and a PCB board mounted at a top of the feed stalk 21. The PCB board includes a dielectric layer 24, a first metal pattern layer is configured on a top surface of the dielectric layer 24 to form the radiator 22, and a second metal pattern layer is configured on a bottom surface of the dielectric layer 24 to form the AMC plane (not shown because it is on a back side of the dielectric layer 24). This embodiment is equivalent to implementing the support in the embodiments shown in FIG. 3A and FIG. 3B with the dielectric layer 24 of the PCB board. The radiating elements shown in FIG. 4A and FIG. 4B may be easily manufactured using a PCB manufacturing process. The remaining configurations of the radiating element according to the present embodiment are similar to the corresponding configurations in the radiating element shown in FIGS. 3A and 3B, and the description will not be repeated here.

The performance of two example radiating elements according to embodiments of the present disclosure (that is, the radiating element shown in FIGS. 3A and 3B, and the radiating element shown in FIGS. 4A and 4B, respectively) is compared with that of the conventional radiating element (the radiating element shown in FIGS. 2A and 2B), as shown in the table below. It can be seen that the radiating elements according to embodiments of the present disclosure provide a narrower azimuth beam width than that of the conventional radiating element, and a higher beam directivity and gain.

| | −3 dB | −10 dB | Peak | |
|---|---|---|---|---|
| | azimuth | azimuth | direc- | Peak |
| | beam width/ | beam width/ | tivity/ | gain/ |
| | degree | degree | dBi | dBi |
| Radiating element of | 67 | 123 | 9.2 | 9 |
| FIGS. 2A and 2B | | | | |
| Radiating element of | 59 | 110 | 10.1 | 9.8 |
| FIGS. 3A and 3B | | | | |
| Radiating element of | 57 | 107 | 10.3 | 10.0 |
| FIGS. 4A and 4B | | | | |

As described above, in some embodiments, the AMC structure 23 may include one AMC plane (“single-layer AMC structure”) or stacked more AMC planes (“multi-layer AMC structure”). In these embodiments, examples of conductor patterns for any of the one AMC plane or stacked more AMC planes may be as shown in FIGS. 6A to 6F. The multi-layer AMC structure 23 may include more pattern units than the single-layer AMC structure (for example, in the case where 3*3=9 conductor units are included in a single MAC plane as shown in FIG. 6A, an AMC structure including n AMC planes stacked may include n*9 conductor units), so that a radiating element with a higher gain can be obtained. In the stacked multiple AMC planes, the distance between two adjacent AMC planes may be between 0.5 mm and 3 mm.

In the embodiment shown in FIG. 7A, the AMC structure that is located below the radiator 22 is a one-layer structure, that is, the AMC structure includes only one AMC plane 231. The AMC plane 231 is configured on an upper surface of a dielectric layer 24 (for example, a dielectric substrate of a PCB). It should be understood that in other embodiments, the AMC plane 231 may alternatively be formed on a lower surface of the dielectric layer 24. In the embodiment shown in FIG. 7B, the AMC structure is a two-layer structure, including two AMC planes 231, 232 stacked. The first-layer AMC plane 231 being configured on the upper surface of the dielectric layer 24, and the second-layer AMC plane 232 being configured on the lower surface of the dielectric layer 24. The AMC structure of the two-layer structure in this embodiment can be easily implemented with a PCB process. In the embodiment shown in FIG. 7C, the AMC structure is a three-layer structure, including three AMC planes 231, 232, 233 stacked. The first layer AMC plane 231 is configured on an upper surface of the first dielectric layer 24-1, the second layer AMC plane 232 is configured on a lower surface of the first dielectric layer 24-1 and in contact with an upper surface of the second dielectric layer 24-2, and the third layer AMC plane 233 is configured on a lower surface of the dielectric layer 24-2. The AMC structure of the three-layer structure in this embodiment can be easily implemented with a multi-layer PCB process.

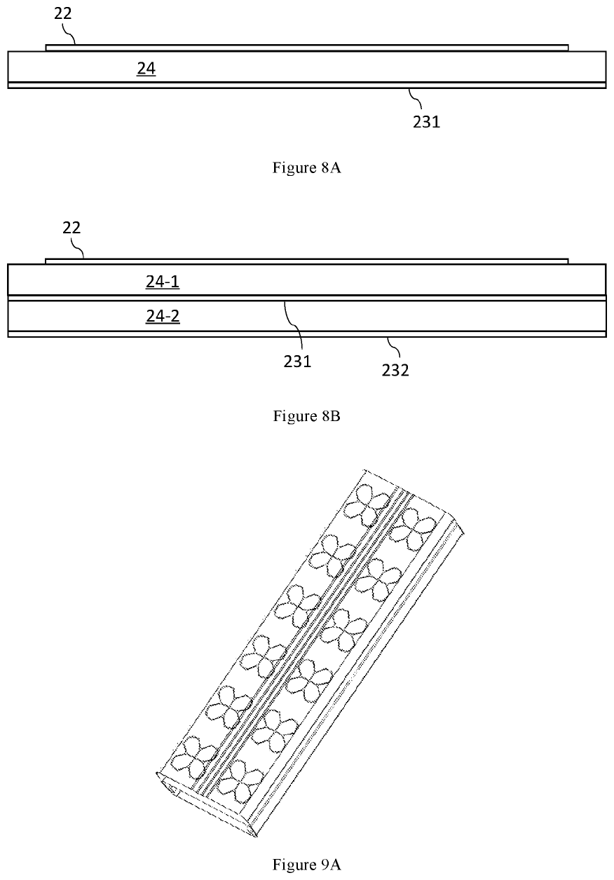

In the embodiment shown in FIG. 8A, the radiator 22 is formed on the upper surface of the dielectric layer 24, and the single-layer AMC structure, for example the AMC plane 231, is formed on the lower surface of the dielectric layer 24, as described with reference to FIGS. 4A and 4B. In the embodiment shown in FIG. 8B, the radiator 22 is configured on an upper surface of the first dielectric layer 24-1; the AMC structure includes a two-layer structure, the first layer AMC plane 231 is configured on a lower surface of the first dielectric layer 24-1, the second layer AMC plane 232 is configured on a lower surface of the second dielectric layer 24-2, and an upper surface of the second dielectric layer 24-2 contacts the first layer AMC plane 231. The radiator 22 in this embodiment, along with the AMC structure of the two-layer structure, can be easily implemented with the multi-layer PCB process.

FIG. 9B is a base station antenna composed of a plurality of radiating elements in the embodiments shown in FIGS. 3A and 3B, and FIG. 9C is a base station antenna composed of a plurality of radiating elements in the embodiments shown in FIGS. 4A and 4B. The bottom of the feed stalk of each radiating element is mounted on the reflector of the base station antenna, so that the radiating element extends from the reflector toward the front of the base station antenna. The plurality of radiating elements are arranged as one or more linear arrays extending along a longitudinal axis of the base station antenna.

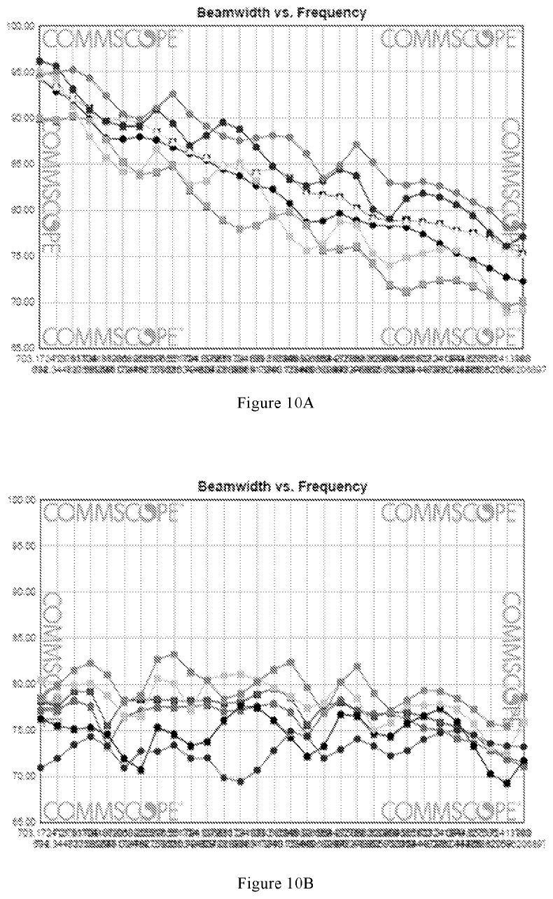

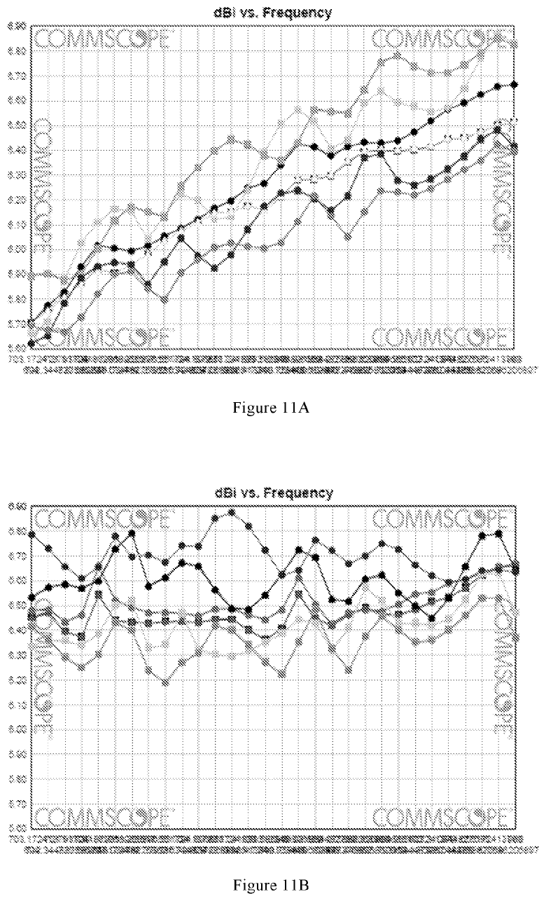

FIGS. 10A-11B are simulation results of performance of the base station antenna in FIG. 9A (which includes conventional radiating elements) and the base station antenna in FIG. 9B, where the width of the reflector of each base station antenna is 430 mm. A plurality of curves are drawn in each of FIGS. 10A-11B, representing performances of the corresponding base station antenna at different electronic downtilt angles, respectively. Since the performance of the base station antenna in FIG. 9C is similar to that of the base station antenna in FIG. 9B, it is not shown. FIG. 10A and FIG. 10B are respective graphs illustrating the variation of the beam width as a function of frequency for the antenna beams generated by the base station antennas of FIG. 9A and FIG. 9B, respectively. It can be seen that the base station antenna according to an embodiment of the present disclosure can obtain a narrower beam width and have better frequency stability. FIG. 11A and FIG. 11B are respective graphs illustrating the variation of in beam directivity as a function of frequency for the antenna beams generated by the base station antennas of FIG. 9A and FIG. 9B, respectively. It can be seen that the base station antenna according to an embodiment of the present disclosure can obtain higher beam directivity and have better frequency stability.

Although some specific embodiments of the present disclosure have been described in detail through examples, those skilled in the art should understand that the above examples are only for illustration rather than for limiting the scope of the present disclosure. The embodiments disclosed herein can be combined arbitrarily without departing from the spirit and scope of the present disclosure. Those skilled in the art should also understand that various modifications can be made to the embodiments without departing from the scope and spirit of the present disclosure. The scope of the present disclosure is defined by the attached claims.

1. A radiating element for a base station antenna, comprising:
a feed stalk;
a radiator mounted on the feed stalk and configured to emit an electromagnetic radiation within an operating frequency band of the radiating element; and
an artificial magnetic conductor (AMC) structure mounted below the radiator and configured to enable the electromagnetic radiation within the operating frequency band to be in-phase reflected,
wherein a distance between the AMC structure and a bottom of the radiator is less than one-tenth ( 1/10) of a height of the feed stalk.

2. The radiating element according to claim 1, wherein a length of the feed stalk is less than one-eighth (⅛) of a corresponding wavelength of a center frequency of the operating frequency band.

3. The radiating element according to claim 1, wherein the AMC structure comprises one AMC plane or stacked more AMC planes.

4. The radiating element according to claim 1, wherein the radiator is formed on a first surface of a printed circuit board (PCB), and the AMC structure is formed on a second surface of the PCB opposite to the first surface.

5. The radiating element according to claim 1, wherein in a plan view parallel to a surface of the AMC structure, an area of the AMC structure completely covers an area of the radiator, and an outer edge of the AMC structure exceeds an outer edge of the radiator.

6. The radiating element according to claim 1, wherein the operating frequency band of the radiating element comprises 0.69-0.96 GHZ, the AMC structure comprises a periodic surface formed by a plurality of repeatedly arranged conductor units, and the plurality of conductor units comprise 3*3 to 7*7 conductor units.

7. The radiating element according to claim 1, wherein the AMC structure comprises a periodic surface formed by repeatedly arranged conductor units, the conductor units comprise one capacitive element and four inductive elements connected in series to the capacitive element, and one or more of the four inductive elements are connected in series to a corresponding capacitive element in an adjacent conductor unit.

8. The radiating element according to claim 7, wherein each of the four inductive elements is connected to the capacitive element from a corresponding junction point of four junction points, and the four junction points are evenly distributed on an outer edge of the capacitive element.

9. The radiating element according to claim 8, wherein the inductive element comprises a conductive trace at least partially surrounding the capacitive element.

10. The radiating element according to claim 7, wherein the inductive element comprises a serpentine conductive trace.

11. A radiating element for a base station antenna, comprising:
a feed stalk; and
a printed circuit board (PCB) mounted on the feed stalk, the PCB comprising a first dielectric layer, a first metal pattern layer and a second metal pattern layer, wherein,
the first metal pattern layer is on a top surface of the first dielectric layer and forms a radiator configured to emit an electromagnetic radiation within an operating frequency band of the radiating element; and
the second metal pattern layer is on a bottom surface of the first dielectric layer and forms at least part of a first artificial magnetic conductor (AMC) plane that is configured to enable the electromagnetic radiation within the operating frequency band to be reflected in-phase,
wherein a distance from the PCB to a bottom of the feed stalk is less than one-eighth (⅛) of a wavelength corresponding to a center frequency of the operating frequency band.

12. The radiating element according to claim 11, wherein the PCB further comprises a second dielectric layer and a third metal pattern layer, a top surface of the second dielectric layer is in contact with and connected to the second metal pattern layer, the third metal pattern layer is on a bottom surface of the second dielectric layer and forms a second AMC plane, and the second AMC plane is configured to enable the electromagnetic radiation within the operating frequency band to be reflected in-phase.

13. The radiating element according to claim 11, wherein, in a plan view parallel to the first AMC plane, an area of the first AMC plane completely covers an area of the radiator, and an outer edge of the first AMC plane exceeds an outer edge of the radiator.

14. The radiating element according to claim 11, wherein the operating frequency band of the radiating element comprises 0.69-0.96 GHz, the first AMC plane comprises a periodic surface formed by a plurality of repeatedly arranged conductor units, and the plurality of conductor units comprise 3*3 to 7*7 conductor units.

15. The radiating element according to claim 11, wherein the first AMC plane comprises a periodic surface formed by repeatedly arranged conductor units, the conductor units comprise one capacitive element and four inductive elements connected in series to the capacitive element, and one or more of the four inductive elements are connected in series to a corresponding capacitive element in an adjacent conductor unit.

16. The radiating element according to claim 15, wherein each of the four inductive elements is connected to the capacitive element from a corresponding junction point of four junction points, and the four junction points are evenly distributed on an outer edge of the capacitive element.

17. The radiating element according to claim 16, wherein the inductive element comprises a conductive trace at least partially surrounding the capacitive element.

18. The radiating element according to claim 15, wherein the inductive element comprises a serpentine conductive trace.

19. A base station antenna, comprising:
a reflector; and
the radiating element according to claim 1, wherein a bottom of a feed stalk of the radiating element is mounted on the reflector so that the radiating element extends from the reflector toward the front of the base station antenna.

20. The base station antenna according to claim 19, wherein the reflector comprises a perfect electric conductor ground plane.

21. The base station antenna according to claim 19, wherein the base station antenna comprises a plurality of radiating elements according to claim 1, and the plurality of radiating elements are arranged as one or more linear arrays extending along a longitudinal axis of the base station antenna.
